(19) United States
(12) Patent Application Publication
(10) Pub. No.: US 2014/0069572 A1
(43) Pub. Date: Mar. 13, 2014

(54) METHOD FOR MAKING A VEHICLE TIRE

(71) Applicant: Continental Reifen Deutschland GmbH, Hannover (DE)

(72) Inventors: Martin Gerighausen, Barsinghausen (DE); Patrick Elsen, Contern (LU); Ewald Kneussel, Barsinghausen (DE); Stefan Linne, Wedemark (DE); Henrik Wende, Wedemark (DE); Claudia Thomfohrde, Leiferde (DE)

(73) Assignee: Continental Reifen Deutschland GmbH, Hannover (DE)

(21) Appl. No.: 14/083,199

(22) Filed: Nov. 18, 2013

Related U.S. Application Data
(63) Continuation of application No. PCT/EP2012/055276, filed on Mar. 26, 2012.

(30) Foreign Application Priority Data
May 18, 2011 (DE) 10 2011 050 458.3

(51) Int. Cl. B29D 30/16

(52) U.S. Cl. CPC B29D 30/16
USPC 156/111

(57) ABSTRACT

A method for making a vehicle tire includes winding a carcass ply onto a carcass drum, wherein the carcass drum includes a device for setting tire cores and a mechanism for folding the carcass ply over a tire core; finishing the tire carcass; removing the tire carcass from the carcass drum; moving the tire carcass over a cambering drum; carrying out a core clamping with segments of the cambering drum with the tire sidewalls clamped with the tire carcass in the region of the tire bead at the cambering drum via core clamping; moving the carcass transfer unit away from the cambering unit; cambering the tire carcass with the tire sidewalls which are on both sides, wherein the tire sidewalls are turned up laterally on the tire carcass by a turning-up device and the tire carcass is combined with the coaxially arranged belt-tread packet; and, finishing the green tire.

### CROSS REFERENCE TO RELATED APPLICATIONS

This application is a continuation application of international patent application PCT/EP2012/055276, filed Mar. 26, 2012, designating the United States and claiming priority from German application 10 2011 050 458.3, filed May 18, 2011, and the entire content of both applications is incorporated herein by reference.

### FIELD OF THE INVENTION

The invention relates to a method for making a vehicle tire.

### BACKGROUND OF THE INVENTION

With conventional vehicle tires, folding the ply in the tire bead around a bead core is a known practice. The ply or the carcass ply is thereby anchored firmly in the tire bead. Conventional vehicle tires of this kind are produced by first arranging the inner layer and the plies as broad layers of material on a tire building drum. The bead core is then placed on the ply and the ply end is folded around the core.

In conventional production methods, the so-called ply folding operation takes place either on the carcass drum or on the following cambering drum. This limits flexibility in the production of different tire designs.

### SUMMARY OF THE INVENTION

It is an object of the invention to provide a method for making a vehicle tire in a simple manner.

It is a further object to ensure high flexibility in the production of different tire designs.

The object is achieved by a method having the following steps:

a) winding at least one carcass ply onto a carcass drum, wherein the carcass drum has a device for setting tire cores and a mechanism for folding the carcass ply over a tire core;

b) finishing the tire carcass on the carcass drum;

c) removing the tire carcass from the carcass drum using a carcass transfer unit;

d) moving the carcass transfer unit with the tire carcass over a cambering drum;

e) carrying out a core clamping operation with segments of the cambering drum, wherein the abutting side walls are clamped to the tire carcass in the region of the tire bead on the cambering drum by this core clamping operation;

f) moving the carcass transfer unit away from the cambering drum;

g) cambering the tire carcass with the side walls, which are held in place on both sides;

wherein the side walls are turned up laterally on the tire carcass by a turning-up device, and the tire carcass is combined with the coaxially arranged belt/tread packet; and,

h) finishing the green tire using a conventional production method.

One advantage of the method according to the invention is that it is distinguished by high flexibility in the production of different tire designs. Through the method, it is, in particular, possible to make tire designs with what is referred to as a C-ply structure, in which part of the carcass ply is arranged so as to extend into the region under the belt/tread packet. The high flexibility of the method likewise makes it possible to arrange part of the side wall either above the belt/tread packet or below the belt/tread packet.

In an advantageous embodiment of the invention, it is provided that, in step a), after the winding on of the carcass plies, a central part of the carcass drum is expanded, and the tire cores are positioned laterally with respect to the offsets formed on the carcass drum.

It is thereby possible to arrange the tire cores in an exact position on the tire carcass.

In another advantageous embodiment of the invention, it is provided that, in step a), after the positioning of the tire cores, the two ply ends are folded around the tire cores via roller levers.

In this way, the ends of the carcass plies are folded firmly around the tire cores.

In another advantageous embodiment of the invention, it is provided that, before step e), the side walls are already arranged on the cambering drum, in the region of the segments, for the core clamping operation.

In this way, it is possible to make certain tire designs which are not possible with conventional methods.

In another advantageous embodiment of the invention, it is provided that, in step e), the side walls are connected firmly to the tire carcass in the region of the tire cores by the core clamping operation with the segments of the cambering drum.

In this method step, the segments for core clamping expand in a radial direction and thereby connect the superposed side walls firmly to the coaxially arranged tire carcass.

In another advantageous embodiment of the invention, it is provided that, after step f), the side walls are folded around the tire cores on the cambering drum via a turning-up device.

It is thereby possible to connect the side walls firmly to the tire carcass in the region of the tire bead.

In another advantageous embodiment of the invention, it is provided that, after the turning up of the side walls, the belt/tread packet is arranged coaxially with the cambering drum and, during the cambering operation, the tire carcass is combined with the belt/tread packet, wherein part of the side wall can be arranged under the tread.

This makes possible a tire configuration in which the side wall is arranged between the tire carcass and the belt/tread packet situated above it.

In another advantageous embodiment of the invention, it is provided that, in step g), the side wall is turned up after the cambering operation, wherein part of the side wall is arranged above the tread.

In this manner, this type of tire design can be produced in a relatively simple manner.

In another advantageous embodiment of the invention, it is provided that the turning-up device is formed on the cambering drum in the form of a multiplicity of roller levers.

As a result, the side walls can be turned up relatively quickly and with high accuracy.

In a further advantageous embodiment of the invention, it is provided that, before step e), the side walls are prefabricated on a separate side wall drum and are then arranged on the cambering drum via a side wall transfer unit.

The cycle time on the cambering drum is thereby considerably reduced.

In another advantageous embodiment of the invention, it is provided that, before step d), the side walls are wound onto the cambering drum as a first tire building component.

As a result, no separate side wall drum is required.

In another advantageous embodiment of the invention, it is provided that, in step b), the finishing of the tire carcass on the carcass drum takes place without folding over any plies.

It is thereby likewise possible to produce tire designs by a conventional method.

### BRIEF DESCRIPTION OF THE DRAWINGS

The invention will now be described with reference to the drawings wherein:

FIG. 1A shows the cambering drum;

FIG. 1B shows the carcass drum;

FIGS. 2 to 4 show the carcass drum on which the folding over of the plies takes place; and,

FIGS. 5 to 9 show the cambering drum on which the tire carcass is arranged and the cambering operation is carried out.

### DESCRIPTION OF THE PREFERRED EMBODIMENTS OF THE INVENTION

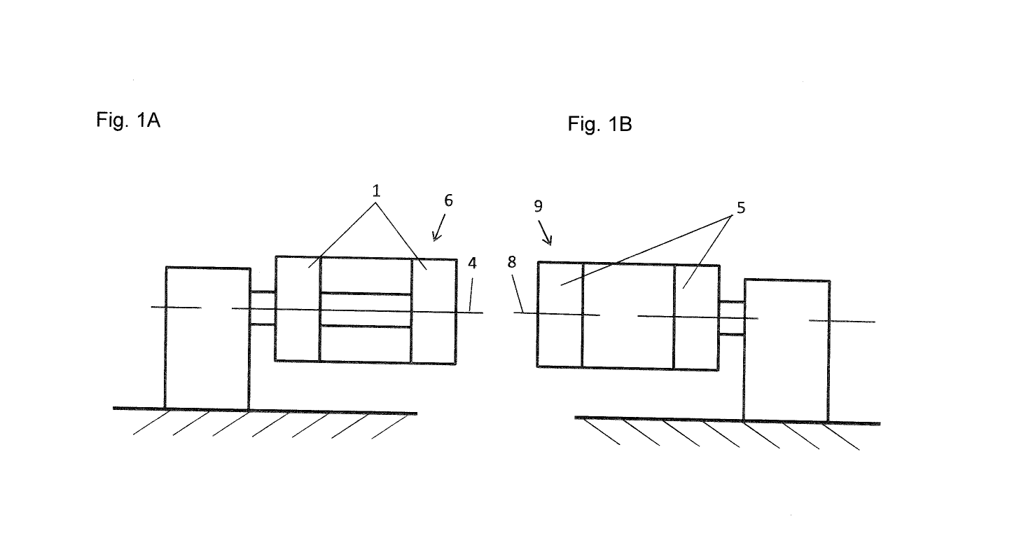

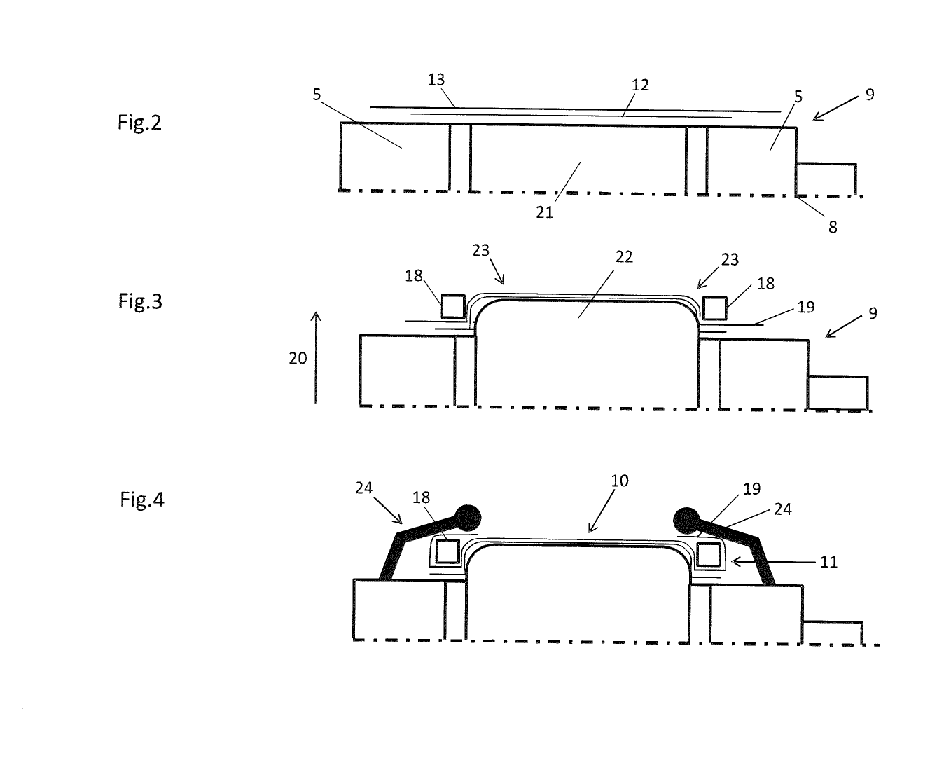

FIG. 1A shows the cambering drum 6 with the drum axis 4 and the mechanism 1 for folding over or turning up the side walls.

FIG. 1B shows the carcass drum 9 on which the tire carcass is made. The carcass drum 9 rotates about the drum axis 8 and has a separate mechanism 5 for folding over the ends of the carcass plies.

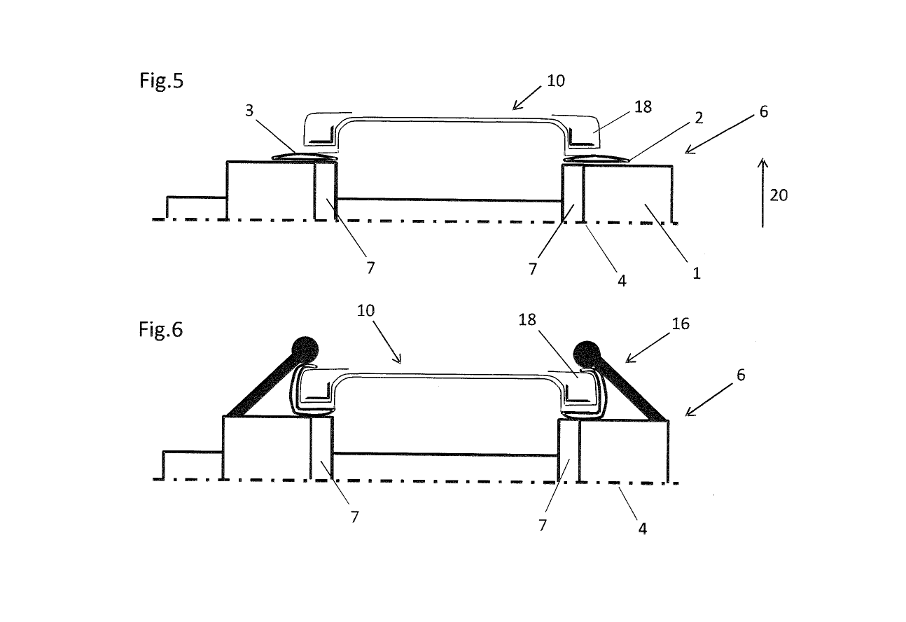

FIG. 2 shows the carcass drum 9 with the drum axis 8. The carcass drum 9 is of substantially rotationally symmetrical construction relative to the drum axis 8, wherein only the upper half is illustrated for the sake of simplicity.

In the center, the carcass drum 9 has a central part 21. The two mechanisms 5 for folding over the carcass plies are arranged laterally. In a first method step, the first carcass ply 12 and the second carcass ply 13 are wound successively onto the carcass drum 9.

FIG. 3 shows the method step wherein the central part 22 of the carcass drum 9 has been expanded in radial direction 20. Two offsets 23 for positioning the tire cores 18 are thereby formed. The tire cores 18 are arranged at the positions shown via core setting devices (not shown).

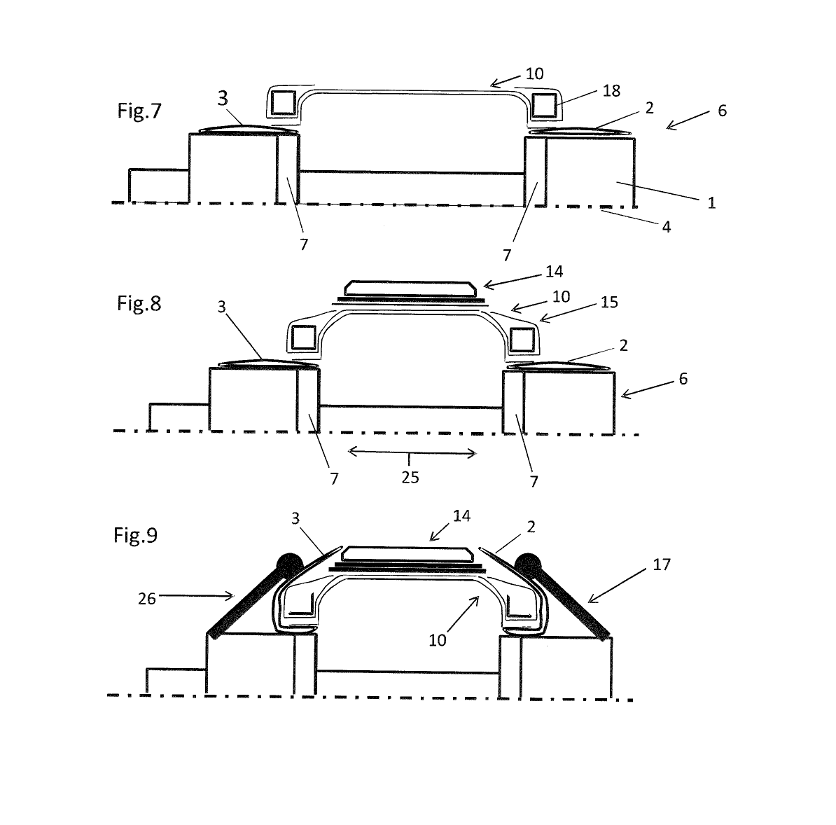

FIG. 4 shows the method step in which the ends of the carcass plies are folded around the core 18. Folding around is accomplished via a multiplicity of roller levers 24, which are moved apart in the manner of fingers. FIGS. 5 and 6 show a first variant embodiment wherein part of the side wall 2 and 3 can be arranged under the belt/tread packet.

The tire carcass 10 with the folded plies has been arranged coaxially with the cambering drum 6 via a carcass transfer unit (not shown). In advance, the right-hand side wall 2 and the left-hand side wall 3 have been arranged on the cambering drum 6. The two side walls 2 and 3 are arranged in the region of the segments 7 for the core clamping operation. The side walls are either prefabricated on a separate side wall drum or wound onto the cambering drum 6 as a first tire building component. In a subsequent step, the segments 7 expand apart in a radial direction 20, with the result that the superposed side walls 2 and 3 are connected firmly to the tire carcass 10. The mechanism 1 for folding over or turning up the side walls 2 and 3 is arranged on both sides of the cambering drum 6.

FIG. 6 shows the cambering drum 6 with the extended roller levers 16 for folding the side walls 2 and 3 around the tire cores 18. In a subsequent method step (not shown), the belt/tread packet is arranged coaxially with the tire carcass 10, and the cambering operation is then initiated. During this cambering operation, the belt/tread packet is combined with the tire carcass 10.

FIGS. 7 to 9 show a further embodiment, in which part of the side wall 2 and 3 can be laid over the belt/tread packet 14. FIG. 7 corresponds substantially to the illustration in FIG. 5. The side walls 2 and 3 have first of all been applied to the cambering drum 6 in a method step which is not shown. The tire carcass 10 is then arranged coaxially with the cambering drum 6, and the side walls 2 and 3 are connected to the tire carcass 10. The side walls 2 and 3 are connected to the tire carcass 10 via radial expansion of the segments 7.

FIG. 8 shows the method step wherein the belt/tread packet 14 has been positioned coaxially with the cambering drum 6, and the tire carcass 10 has been combined with the belt/tread packet 14 via a cambering operation. In this cambering operation, the segments 7 are moved together in an axial direction 25 for core clamping.

FIG. 9 shows the method step in which the roller levers 17 swing apart in a radial direction to turn up the side walls 2 and 3. In this process, the side walls 2 and 3 are turned up on the tire carcass 10, thus enabling part of the side walls 2 and 3 to be arranged over the belt/tread packet 14. The green tire 26 is then finished via a conventional method.

It is understood that the foregoing description is that of the preferred embodiments of the invention and that various changes and modifications may be made thereto without departing from the spirit and scope of the invention as defined in the appended claims.

### LIST OF REFERENCE NUMERALS

### (Part of the Description)

1 mechanism for folding over or turning up the side walls
2 right-hand side wall
3 left-hand side wall
4 drum axis of the cambering drum
5 mechanism for folding over the carcass plies
6 cambering drum
7 segments for core clamping
8 drum axis of the carcass drum
9 carcass drum
10 tire carcass with folded over plies
11 folded over plies with core
12 first carcass ply
13 second carcass ply
14 belt/tread packet
15 cambering operation
16 roller levers
17 roller levers during the turning up of the side walls
18 tire core
19 end of the carcass ply
20 radial direction
21 central part of the carcass drum
22 central part of the carcass drum expanded in a radial direction
23 offsets for positioning the tire cores
24 roller levers for folding over the ends of the carcass plies
25 axial moving together of the segments
26 green tire

What is claimed is:

1. A method for making a vehicle tire having a tire carcass with a carcass ply, side walls, tire beads with tire cores, and a belt/tread packet including a tire belt and a tread, a carcass transfer unit, and a cambering drum, the method comprising the steps of:
(a) providing a carcass drum including a device for positioning the tire cores and a folding mechanism for folding the carcass ply over the tire cores;
(b) winding at least one carcass ply onto the carcass drum;
(c) finishing the tire carcass on the carcass drum;
(d) removing the tire carcass from the carcass drum using a carcass transfer unit;
(e) moving the tire carcass transfer unit with the tire carcass over the cambering drum;
(f) performing a core clamping procedure with segments of the cambering drum wherein abutting side walls are clamped to the tire carcass in the region of the tire bead on the cambering drum via the core clamping;
(g) moving the carcass transfer unit away from the cambering drum;
(h) cambering the tire carcass with the side walls, which are placed against both sides of the tire carcass, wherein the side walls are turned up laterally on the tire carcass via a turning up device and the tire carcass is combined with the coaxially arranged belt/tread packet; and,
(i) finishing the green tire using a conventional production method.

2. The method of claim 1 further comprising the steps of:
expanding a middle portion of the carcass drum after said winding of the at least one carcass ply onto the carcass drum; and,
positioning the tire cores laterally with respect to the offsets formed on the carcass drum.

3. The method of claim 2, wherein the carcass ply has two ends, the method further comprising the step of turning over each of the ends of the carcass ply around the tire cores via rolling levers, after said positioning of the tire cores laterally with respect to the offsets formed on the carcass drum.

4. The method of claim 1, wherein the side walls are already arranged on the cambering drum in the region of the segments for the core clamping procedure prior to step (f).

5. The method of claim 1, wherein in step (f), the side walls are fixedly connected to the tire carcass in the region of the tire cores via the core clamping procedure with the segments of the cambering drum.

6. The method of claim 1, wherein after step (g), the side walls are folded around the tire cores on the cambering drum via the folding mechanism.

7. The method of claim 1 further comprising the step of:
arranging the belt/tread packet coaxially to the cambering drum after the turning up of the side walls; and,
combining the tire carcass with the belt/tread packet during said cambering of step (h), wherein a portion of each of the side walls is arranged below the tread.

8. The method of claim 1, wherein in step (h), the side walls are turned up after said cambering tire carcass with the side walls, wherein a portion of the side wall is arranged over the tread.

9. The method of claim 1, wherein the turning up device is configured as a plurality of roller levers on the cambering drum.

10. The method of claim 1 further comprising the steps of:
prior to step (f), prefabricating the side walls on a separate side wall drum; and,
then arranging the side walls on the cambering drum via a side wall transfer unit.

11. The method of claim 1 further comprising the step of winding the side walls onto the cambering drum as a first tire building component prior to step (e).

12. The method of claim 1, wherein in step (c), said finishing the tire carcass on the carcass drum is performed without folding over any plies.
